(19) United States
(12) Patent Application Publication
(10) Pub. No.: US 2004/0042930 A1
(43) Pub. Date: Mar. 4, 2004

(54) Reaction chamber with capillary lock for fluid positioning and retention

(76) Inventors: Charles E. Clemens, Encinitas, CA (US); Lanny Gorton, San Diego, CA (US); David Vrane, San Jose, CA (US)

Correspondence Address: PATTON BOGGS LLP, 8484 WESTPARK DRIVE, SUITE 900, MCLEAN, VA, 22102, US

(21) Appl. No.: 10/231,008

(22) Filed: Aug. 30, 2002

(51) Int. Cl. G01N 1/10

(52) U.S. Cl. 422/61; 436/180; 422/99; 422/100; 422/102

(57) ABSTRACT

The present invention relates to a reaction chamber for use in processing liquid samples, particularly liquid specimens from medical patients. The reaction chamber of the present invention comprises a primary chamber and a capillary channel located at each of an inlet and an outlet of the primary chamber. The reaction chamber also has a capillary lock feature associated with it. The capillary lock feature positions the liquid specimen in the primary chamber and the capillary channels and retains the liquid sample therein. The reaction chamber of the present invention may be employed in a cartridge or other device that processes such liquid samples.

### BACKGROUND OF THE INVENTION

1. Field of the Invention

The present invention relates generally to a device useful in patient sample processing and, more particularly, to a reaction chamber having a capillary lock feature for providing fluid positioning and retention.

2. Discussion of the Background

Current methods for patient sample processing are typically done manually with pipettes, vials, chemicals and a heater. This work is typically done in a laboratory. Current processes and equipment, while very accurate, are both time consuming and labor intensive. It is desirable, therefore, to have an inexpensive “disposable” apparatus to accomplish the sample processing in an automated fashion such that the equipment assists in the processing steps.

### SUMMARY OF THE INVENTION

The present invention relates to a reaction chamber used for processing liquid samples and, in particular, liquid specimens from medical patients. The reaction chamber comprises a primary chamber having an inlet and an outlet with a capillary channel located at each of the inlet and the outlet. The capillary channels have a capillary lock feature that positions the liquid in the reaction chamber to retain the sample therein.

The reaction chamber of the present invention has several advantages. First, the reaction chamber advantageously positions the liquid sample and then maintains the position of the sample within the reaction chamber during processing of the sample. The reaction chamber of the present invention also minimizes evaporation (i.e., sample loss) during sample processing such as, for example, during a heating cycle. Next, the reaction chamber is capable of mass production, i.e., it may advantageously be incorporated as a component of a multi-process cartridge, which may be constructed with very inexpensive materials, all of which result in an inexpensive apparatus for processing patient samples. Furthermore, use of the reaction chamber as part of a multi-process cartridge allows for automated liquid patient sample processing, thereby providing a low cost alternative to expensive manual processing.

The above and other features and advantages of the present invention will become more apparent from the following detailed description of the presently preferred embodiments, particularly when considered in conjunction with the drawings, and to the appended claims.

### BRIEF DESCRIPTION OF THE DRAWINGS

FIG. 1a is a top view of a cartridge containing the capillary locks of the present invention.

FIG. 1b is a fragmentary sectional view taken generally along the line A-A of FIG. 1a.

FIG. 2a is a bottom view of the top half of the cartridge containing the capillary locks of the present invention.

FIG. 2b is a fragmentary sectional view taken generally along the line C-C of FIG. 3a.

FIG. 3 is an isometric view of the top half of the cartridge containing the capillary locks of the present invention.

FIG. 4 is an enlarged view along circle B of FIG. 1b.

### DETAILED DESCRIPTION OF THE INVENTION

While this invention is satisfied by embodiments in many different forms, there will herein be described in detail preferred embodiments of the invention, with the understanding that the present disclosure is to be considered as exemplary of the principles of the invention and is not intended to limit the invention to the embodiments illustrated and described. Numerous variations may be made by persons skilled in the art without departure from the spirit of the invention. The scope of the invention will be measured by the appended claims and their equivalents.

The present invention is a reaction chamber for use in processing liquid samples, particularly those from medical patients. The reaction chamber of the present invention comprises a primary chamber having an inlet and an outlet. The reaction chamber further comprises first and second capillary channels, each of which has first end and a second end. The second end of the first capillary channel is attached to the inlet of the primary chamber, while the first end of the second capillary channel is attached to the outlet of the primary chamber. The reaction chamber also has a capillary lock feature associated with it. The reaction chamber of the present invention may be employed in a cartridge or other device that processes liquid specimens.

The capillary lock feature of the reaction chamber of the present invention works to position a liquid sample in the reaction chamber (i.e., the reaction chamber and the first and second capillary channels) and then lock the liquid therein so as to retain it there until the sample is subsequently moved. The capillary lock feature provides an incremental holding force on the liquid sample resting within the reaction chamber, as well as minimizing evaporation during sample heating. Firstly, the phenomenon of capillarity occurs when the surface of a liquid sample comes in contact with a solid, and the liquid is encouraged to move depending on the competing forces of: (1) liquid-to-solid adhesion (or attraction) and (2) liquid-to-liquid cohesion. In this case, the net effect of the small capillary channels at the inlet and outlet of the primary chamber is that the liquid sample is attracted to fill them and adheres to the small internal surface area. It would require a raised force to move the liquid sample from that position. Secondly, the capillary channels have a cross-sectional area that is significantly smaller than the cross-sectional area of the primary chamber. When the reaction chamber is heated for processing, only the small ends of the capillary channels are exposed to the vent, thereby significantly reducing sample evaporation.

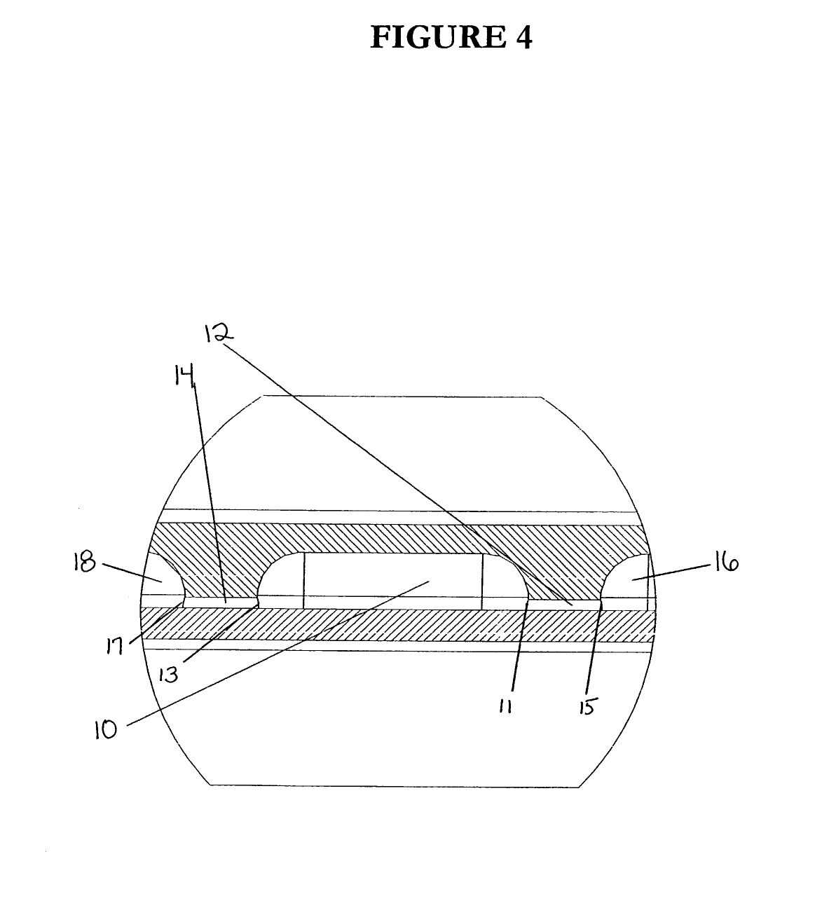

The reaction chamber according to the present invention will now be described by reference to the figures. Referring first to FIG. 4, there is shown a primary chamber 10 having an inlet 11 and an outlet 13. As seen in FIG. 4, primary chamber 10 is preferably D-shaped. Primary chamber 10 closes down into first capillary channel 12 at inlet 11 and second capillary channel 14 at outlet 13. Together, primary chamber 10 and capillary channels 12, 14 have a predefined volume, which is used to contain a liquid sample for reaction therein. This volume capacity can be varied so that different fixed volumes can be measured.

Capillary channels 12, 14 are also preferably D-shaped, similar to primary chamber 10, but are substantially smaller in cross section so as to minimize exposed liquid surface area. Each of capillary channels 12, 14 connects with a chamber 16, 18 on its respective side of reaction chamber 10. Like primary chamber 10, each of chambers 16, 18 have an inlet and an outlet. In this way, capillary channel 12, which is connected at its second end to inlet 11 of primary chamber 10, is connected at its first end to outlet 15 of chamber 16. Similarly, capillary channel 14 is connected at its first end to outlet 13 of primary chamber 10 and at its second end to inlet 17 of chamber 18. The capillary lock is formed at each of the first end of capillary channel 12 and the second end of capillary channel 14 to position and retain the liquid sample with the reaction chamber (i.e., primary chamber 10 and capillary channels 12, 14).

The transition from each of capillary channels 12, 14 to chambers 16, 18, respectively, is a sharp-edged (i.e., nearly a right angle) transition in the walls. The capillary lock feature comprises the transitions from the small cross-section capillary channels 12, 14 to the larger chambers on either side (i.e., chambers 16, 18). The sharp increase in cross sections from capillary channel to larger chamber causes the liquid to be held there through surface tension. The capillary lock feature, therefore, works to hold the liquid sample in chamber 10 and capillary channels 12, 14 without the need for a mechanical valve or holding pressure. The capillary lock feature of the reaction chamber also serves to minimize liquid losses while the reaction chamber is being used to chemically treat and/or heat liquid samples. When the liquid sample is heated as part of the processing thereof, the capillary lock feature also helps to minimize sample evaporation and/or movement caused by potential de-gassing.

According to the present invention, a liquid sample such as, for example, a blood or urine specimen from a patient, is introduced into primary chamber 10 and fills the primary chamber. When the liquid sample reaches capillary channels 12, 14 at each end of chamber 10, it is pulled through to the opposite ends of the channels and stops. Capillary action causes the liquid sample to completely fill the capillary channels, while the capillary locks create a resistance to further flow or movement of the liquid sample. Surface tension prevents the liquid from flowing past the sharp transition from capillary channels 12, 14 to the next chambers (i.e., chamber 16, 18) in sequence. This capillary lock feature of the present invention allows the liquid sample to be roughly positioned in the chamber, where it then self-centers and locks in place.

Primary chamber 10 contains reagents required for the reactions that occur within the reaction chamber. Preferably, the reagents are dried down in the reaction chamber itself. The fact that the reagents are dried down in the reaction chamber can drastically change the surface wetting properties of the liquid sample, which can in turn change the flow characteristics. Typically, reagents can reduce the surface tension to the point of defeating the capillary lock feature. Drying down the reagents tends to eliminate this problem; however, dried reagents too close to the edges of the capillaries can still wick the fluid into the next chamber. Because the dried reagents in the reaction chamber may interfere with the surface tension, a smaller spherical locking chamber may be placed between the reaction chambers.

The reaction chamber of the present invention may be fabricated as part of a cartridge or similar device used in patient sample processing. The present invention finds particular application in an integrated cartridge for automated DNA amplification, such as that which is described in co-pending U.S. application Ser. No. 10/160,191, filed Jun. 4, 2002 (Attorney Docket No. 20187-114), which application is incorporated herein by reference. While the present invention will now be described as part of such an integrated cartridge, the present invention is not so limited.

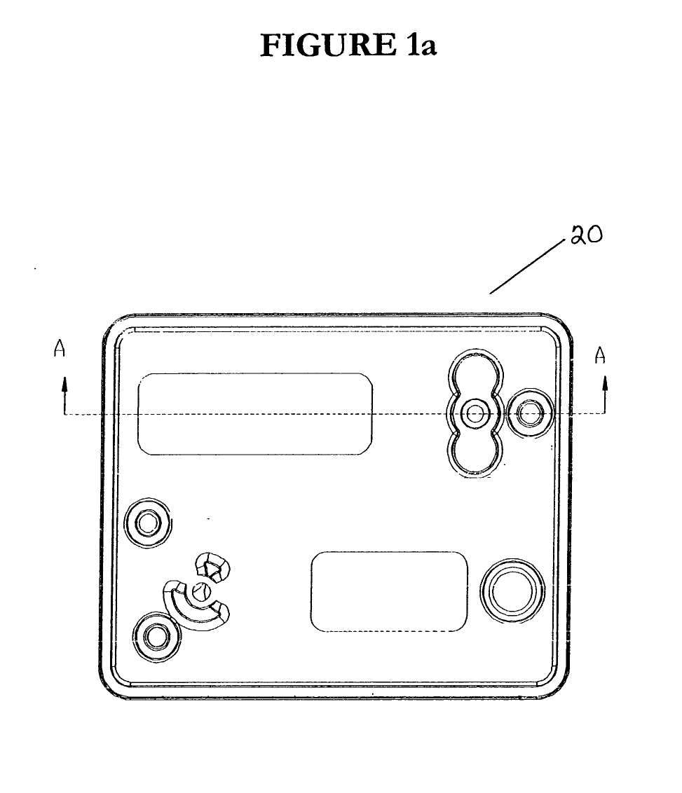

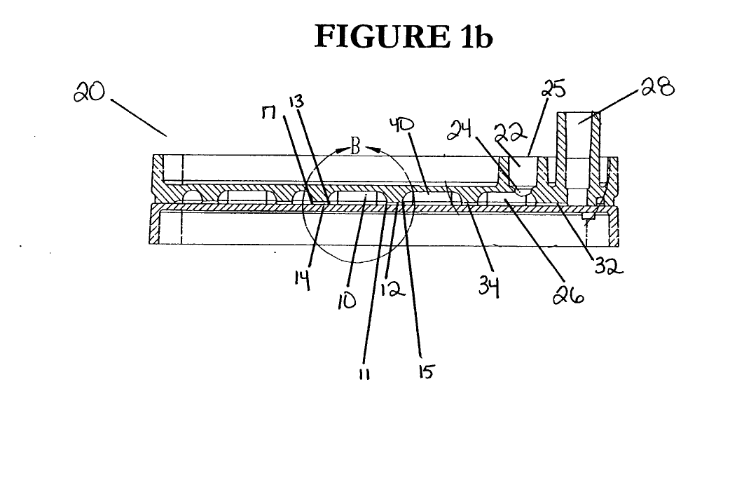

Referring first to FIG. 1a, there is shown an exemplary device, in this case an integrated cartridge 20, which contains the reaction chamber of the present invention. Cartridge 20 generally comprises a sealed, two-part device with various internal fluidic channels and chambers, including reaction chambers containing dried reagents. The chambers are used to measure an aliquot, provide heat and reagents for reactions, and control the position of the fluid bolus for each reaction step. Fluid channels connect the chambers in series.

FIG. 1b, which is taken generally along line A-A of FIG. 1a, shows the cartridge halves bonded together with a cross section of the fluid path sequence shown in elevation. Referring now to FIG. 1b, there is shown a liquid inlet well 22 into which a user inputs a liquid sample. FIG. 1b also shows a chamber entry 24, a liquid input chamber 26 and an air drive entry port 28.

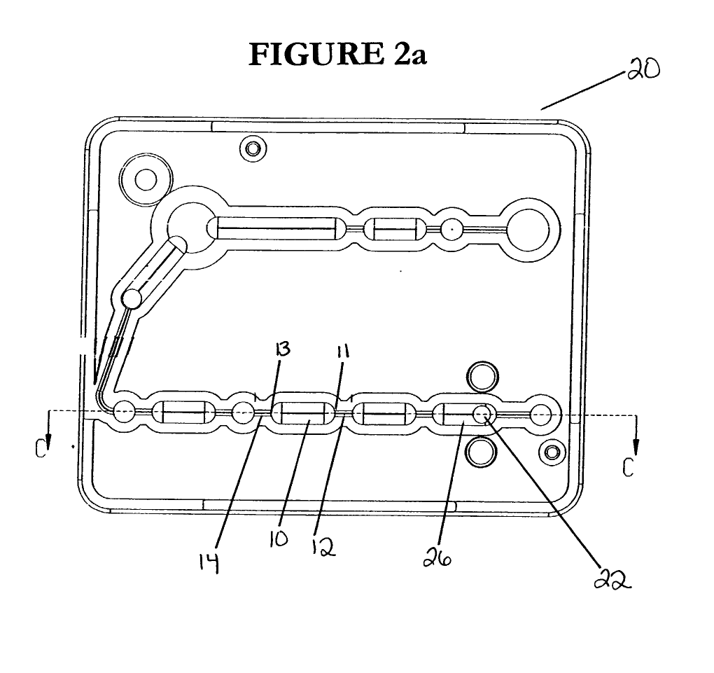

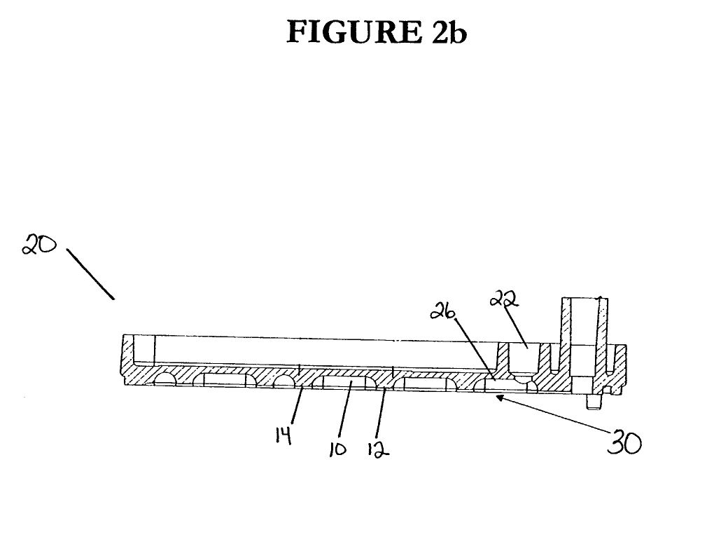

FIG. 2a shows the top half of cartridge 20 containing the reaction chamber of the present invention. The top half of cartridge 20 preferably contains the internal fluidic cavities. FIG. 2a shows the fluidic cavities of an entire liquid processing sequence, including liquid inlet well 22, liquid input chamber 26, primary chamber 10, including inlet 11 and outlet 13, and capillary channels 12, 14.

FIG. 2b, which is taken generally along the line C-C of FIG. 2a, provides a side view of the top half of cartridge 20. The elevation of the fluidic cavities with respect to the bonding surface 30 of cartridge 20 can be seen in FIG. 2b. Bonding surface 30 is used to bond the cartridge halves together, preferably using an ultraviolet adhesive or the like. Preferably, the bonding is done by silk screening an adhesive pattern onto the cartridge halves. Silk screening is preferred because it is less abusive to the dried reagents in the reaction chamber then other bonding techniques. The adhesive pattern is about 0.005 inches thick and matches the outline of the walls of the cartridge top half. The pattern is preferably set back from the inside edges of the channels by about 0.020 inches so that it does not squeeze into them during assembly. The two cartridge halves are then clamped together and exposed to ultraviolet light to cure the adhesive and form the assembled cartridge.

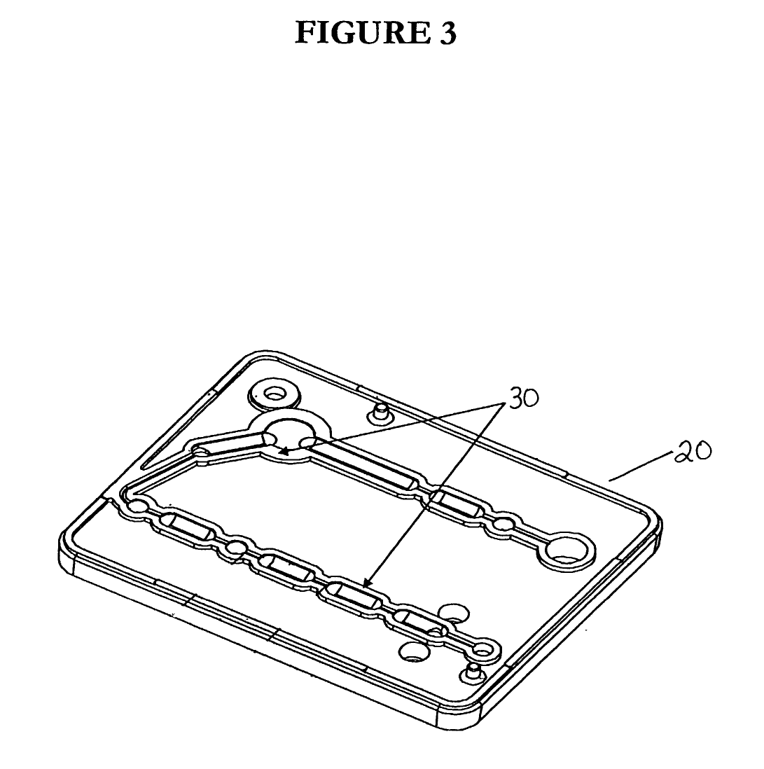

FIG. 3 is an isometric view of the top half of cartridge 20 containing the reaction chamber of the present invention. Again, the fluid cavities of an entire liquid processing sequence can be seen therein. The flat, raised surface surrounding the fluid channels comprises bonding surface 30.

The capillary lock feature is also useful in chambers other than the reaction chamber of the present invention. For example, the capillary lock feature may also be used in connection with the liquid input chamber of a self-metering volume input device, as disclosed in co-pending U.S. application Ser. No. ______ (Attorney Docket No. 20187-113), which application is incorporated herein by reference. Such a self-metering volume input device will be described in more detail below, with reference to FIG. 1b.

In operation, a user places the liquid patient sample into liquid inlet well 22 of cartridge 20. Chamber entry 24 connecting liquid inlet well 22 to liquid input chamber 26 allows the liquid sample to flow down into input chamber 26 and fill it. When the sample reaches capillary channels 32, 34 at each end of chamber 26, it is pulled through to the opposite ends of the channels and stops. The capillary lock feature may also be located in capillary channels 32, 34; therefore, surface tension prevents the liquid from flowing past the sharp transitions of capillary channels 32, 34. The capillary lock feature, therefore, allows the fluid bolus to be roughly positioned in chamber 26 and capillary channels 32, 34 before it self-centers and locks in place.

After input chamber 26 has measured and locked the required volume for processing, the remainder of the input volume accumulates and remains in inlet well 22 above it. The user places a sealing means (not shown), preferably tape or a self-adhesive label, over the entrance 25 of inlet well 22 to form a vacuum and retain the excess liquid therein when the sample in chamber 26 is moved from input chamber 26. Application of a positive pressure through air drive entry port 28 moves the sample out of input chamber 26 and through the sequence of chambers and capillary channels. External pumps are used to move the liquid sample through cartridge 20. For example, an air pump (not shown) connects to air drive entry port 28 adjacent liquid inlet well 22. Air drive entry port 28 is the cartridge interface point for a means of pumping air (i.e., the air pump) into cartridge 20 and moving the liquid sample to subsequent chambers downstream. This pump pushes only air, which moves the liquid sample from input chamber 26 through the other chambers, including primary chamber 10. The capillary channels of cartridge 20 allow the drive fluid to be air. The compliance of air prevents accuracy in other systems and causes other systems to use deionized water as a system fluid for stiffness.

When the fluid movement sequence starts, the air pump moves the liquid sample forward slowly into sensing chamber 40, where an optical sensor detects the meniscus of the liquid sample. The instrument then knows the exact location of the leading edge of the liquid and proceeds with the predetermined number of steps to move the liquid into primary chamber 10 and capillary channels 12, 14. The preferred method of moving the liquid is to not use the optical sensors at all. If the capillary lock feature of input chamber 26 functions properly, then the starting position will be known, and the air volume needed to reach primary chamber 10 will be consistent. The meniscus sensing optics may, therefore, be eliminated by knowing the starting position of the fluid.

The reaction chamber contains reagents. When the fluid bolus is moved into the reaction chamber, it is held there for a specified time to allow for dissolution and reaction of the reagents. When the fluid bolus in the reaction chamber is heated, capillary channels 12, 14 are vented to prevent pressure buildup that would move the fluid bolus out of position. The small exposed surface inside of capillary channels 12, 14 also essentially eliminates evaporation during the heating cycle.

Having now fully described the invention with reference to certain representative embodiments and details, it will be apparent to one of ordinary skill in the art that changes and modifications can be made thereto without departing from the spirit or scope of the invention as set forth herein.

What is claimed is:

1. A reaction chamber, comprising:
a primary chamber having an inlet and an outlet;
first and second capillary channels, each having a first end and a second end, wherein the second end of the first capillary channel is attached to the inlet of the primary chamber and the first end of the second capillary channel is attached to the outlet of the primary chamber; and
a capillary lock formed at each of the first end of the first capillary channel and the second end of the second capillary channel to position and retain a liquid sample within the reaction chamber.

2. The reaction chamber of claim 1, wherein the chamber is D-shaped.

3. The reaction chamber of claim 2, wherein the capillary channels are D-shaped.

4. The reaction chamber of claim 1, wherein the capillary locks use surface tension to retain the liquid sample within the primary chamber.

5. The reaction chamber of claim 1, further comprising one or more reagents.

6. The reaction chamber of claim 5, wherein the one or more reagents are dried reagents.

7. An integrated cartridge, comprising a reaction chamber, wherein the reaction chamber comprises:
a primary chamber having an inlet and an outlet;
first and second capillary channels, each having a first end and a second end, wherein the second end of the first capillary channel is attached to the inlet of the primary chamber and the first end of the second capillary channel is attached to the outlet of the primary chamber; and
a capillary lock formed at each of the first end of the first channel and the second end of the second channel to position and retain a liquid sample within the reaction chamber.

8. The integrated cartridge of claim 7, wherein the reaction chamber is D-shaped.

9. The integrated cartridge of claim 8, wherein the capillary channels are D-shaped.

10. The integrated cartridge of claim 7, wherein the reaction chamber further comprises one or more reagents.

11. The integrated cartridge of claim 10, wherein the one or more reagents are dried reagents.

12. The integrated cartridge of claim 7, further comprising at least one additional chamber and at least one additional capillary channel connected in sequence to the reaction chamber.

13. The integrated cartridge of claim 12, wherein the at least one additional chamber has an inlet and an outlet and the at least one additional capillary channel has a first end and a second end.

14. The integrated cartridge of claim 13, wherein the second end of the second capillary channel is attached to the inlet of the at least one additional chamber and the first end of the at least one additional capillary channel is attached to the outlet of the at least one additional chamber.

15. A method of using a reaction chamber, the reaction chamber comprising a primary chamber having an inlet and an outlet, first and second capillary channels each having a first end and a second end such that the second end of the first capillary channel is attached to the inlet of the primary chamber and the first end of the second capillary channel is attached to the outlet of the primary chamber, and a capillary lock formed at each of the first end of the first capillary channel and the second end of the second capillary channel, wherein the method comprises:
placing a liquid sample in the primary chamber;
allowing the liquid sample to flow from the primary chamber into the first and second capillary channels; and
retaining the liquid sample in the reaction chamber using the capillary locks.

16. The reaction chamber of claim 15, wherein the capillary locks retain the liquid sample within the reaction chamber by surface tension.
